(19) United States
(12) Patent Application Publication
(10) Pub. No.: US 2026/0323347 A1
(43) Pub. Date: Oct. 15, 2026

(54) UE-CENTRIC PROCESSING IN CASE OF MULTIPLE CHANNEL STATE INFORMATION REFERENCE SIGNAL RESOURCES

(71) Applicant: QUALCOMM Incorporated, San Diego, CA (US)

(72) Inventors: Hyojin LEE, San Diego, CA (US); Yu ZHANG, San Diego, CA (US); Jing SUN, San Diego, CA (US)

(21) Appl. No.: 19/174,867

(22) Filed: Apr. 9, 2025

(51) Int. Cl. H04W 24/10; H04L 5/00

(52) U.S. Cl. CPC H04W 24/10; H04L 5/0048

(57) ABSTRACT

Certain aspects of the present disclosure provide techniques for signal processing in scenarios where multiple channel state information reference signal (CSI-RS) resources are configured. An example method, performed at a wireless node, generally includes obtaining signaling configuring multiple CSI-RS resources, measuring one or more reference signals (RSs) via the CSI-RS resources, obtaining a grant that is configured to schedule transmission of a signal from the wireless node, wherein the grant indicates a reference modulation and coding scheme (MCS), identifying a differential MCS based on the measurement and one of the multiple CSI-RS resources, and outputting the signal for transmission, responsive to the grant, wherein the signal is output using the reference MCS and the differential MCS.

### FIELD OF THE DISCLOSURE

Aspects of the present disclosure relate to wireless communications, and more particularly, to techniques for signal processing in scenarios where multiple channel state information reference signal (CSI-RS) resources are configured.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a wireless node. The method includes obtaining signaling configuring multiple channel state information reference signal (CSI-RS) resources; measuring one or more reference signals (RSs) via the CSI-RS resources; obtaining a grant that is configured to schedule transmission of a signal from the wireless node, wherein the grant indicates a reference modulation and coding scheme (MCS); identifying a differential MCS based on the measurement and one of the multiple CSI-RS resources; and outputting the signal for transmission, responsive to the grant, wherein the signal is output using the reference MCS and the differential MCS.

Another aspect provides a method for wireless communication. The method includes outputting signaling configuring a wireless node with multiple channel state information reference signal (CSI-RS) resources; outputting one or more reference signals (RSs) via the CSI-RS resources; outputting a grant that is configured to schedule transmission of a signal from the wireless node, wherein the grant indicates a reference modulation and coding scheme (MCS); obtaining, from the wireless node, the signal and an indication of a differential MCS associated with one of the CSI-RS resources; and processing the signal based on the reference MCS and the differential MCS.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates an example call flow diagram for codebook based multiple-input multiple-output (MIMO) transmissions.

FIG. 6 illustrates an example call flow diagram for non-codebook based MIMO transmissions.

FIG. 7 illustrates an example call flow diagram for UE-centric uplink precoding, in accordance with aspects of the present disclosure.

FIG. 8 illustrates an example timing diagram for UE-centric uplink precoding, in accordance with aspects of the present disclosure.

FIGS. 9A and 9B illustrate example scenarios with multiple channel state information reference signal (CSI-RS) resources, in accordance with aspects of the present disclosure.

FIG. 10 illustrates an example call flow diagram for UE-centric uplink precoding, in accordance with aspects of the present disclosure.

FIG. 11 illustrates another example call flow diagram for UE-centric uplink precoding, in accordance with aspects of the present disclosure.

FIGS. 12A and 12B illustrate example timing diagrams for UE-centric uplink precoding, in accordance with aspects of the present disclosure.

FIG. 13 illustrates examples of uplink control information (UCI) payload, in accordance with aspects of the present disclosure.

FIG. 14 illustrates an example of fallback operation, in accordance with aspects of the present disclosure.

FIG. 15 depicts a method for wireless communications.

FIG. 16 depicts a method for wireless communications.

FIG. 17 depicts aspects of an example communications device.

### DETAILED DESCRIPTION

Aspects of the present disclosure relate to wireless communications, and more particularly, to techniques for signal processing in scenarios where multiple channel state information reference signal (CSI-RS) resources are configured.

MIMO (Multiple-Input Multiple-Output) generally refers to wireless communication that uses multiple antennas at both the transmitter and receiver to improve data throughput, spectral efficiency, and link reliability. By leveraging spatial multiplexing, MIMO can transmit multiple data streams simultaneously over the same frequency channel, significantly increasing capacity without requiring additional bandwidth. MIMO may also enhance signal quality through diversity techniques that mitigate fading and interference. For these reasons, MIMO is widely used in modern wireless networks.

For example, in 5G/NR networks, MIMO may be used for uplink transmission from a user equipment (UE) to a network entity. NR supports two different uplink (UL) MIMO modes: codebook (CB) based on non-codebook (NCB) based, each with advantages and disadvantages. For example, while CB based MIMO is a relatively straightforward procedure and does not require uplink and downlink channel reciprocity, it typically involves a relatively low resolution codebook. This makes it difficult for CB based MIMO to support subband precoding and provides limited flexibility for different UE antenna architectures. On the other hand, NCB based MIMO typically has higher resolution, is transparent to the network, and can support phase-continuous frequency-selective precoding. However, the NCB based procedure typically has a longer latency and cannot support block-wise subband precoding.

Aspects of the present disclosure, however, provide a UE-centric MIMO framework that may help support high-resolution (HR) and subband (SB) precoding, effectively achieving the best of both CB and NCB based UL MIMO modes. As will be described in greater detail below, the techniques proposed herein may be applied in scenarios where a UE is configured with multiple channel state information reference signal (CSI-RS) resources.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

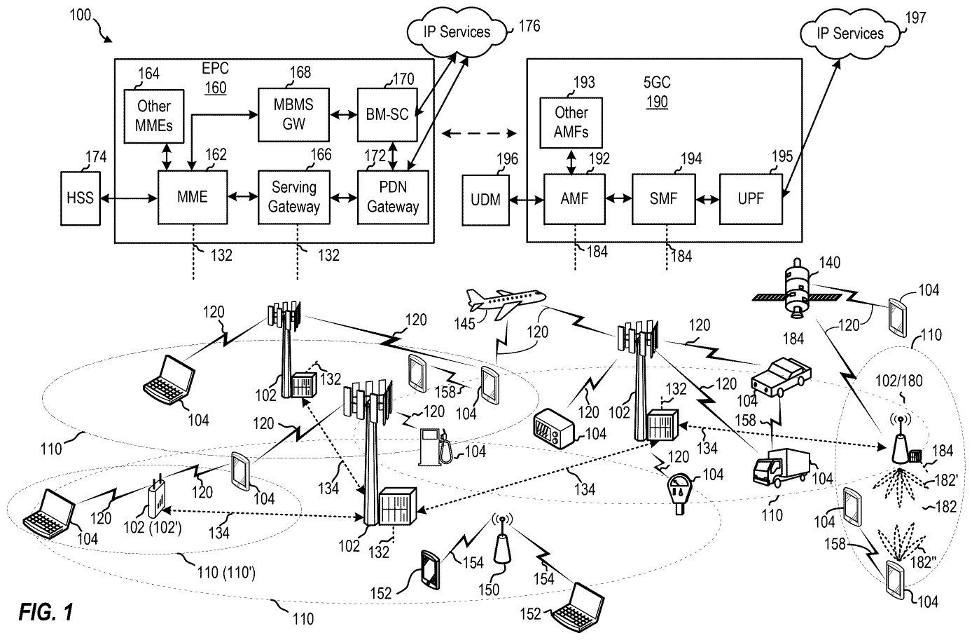

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

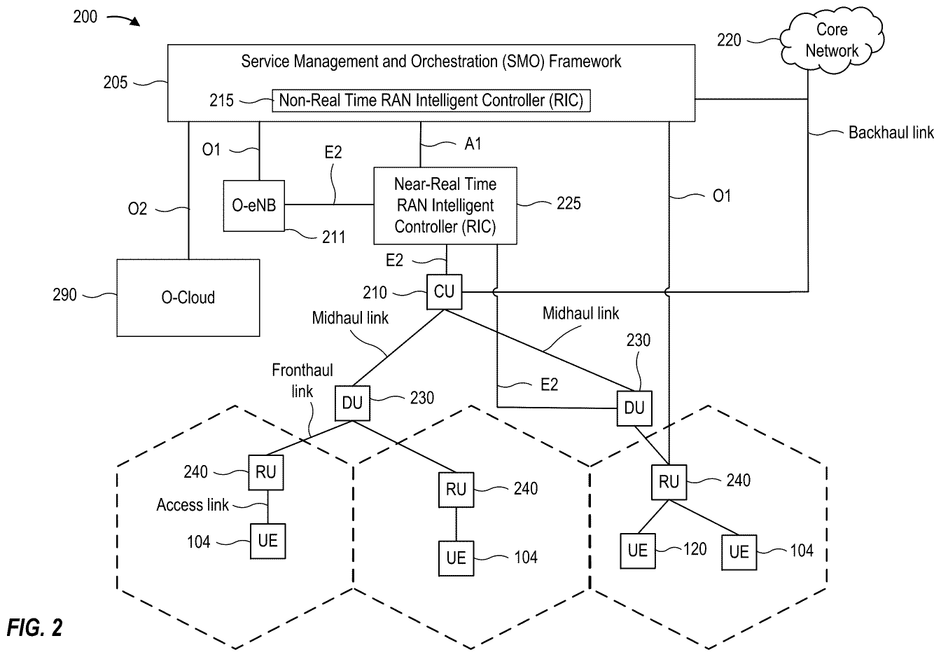

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

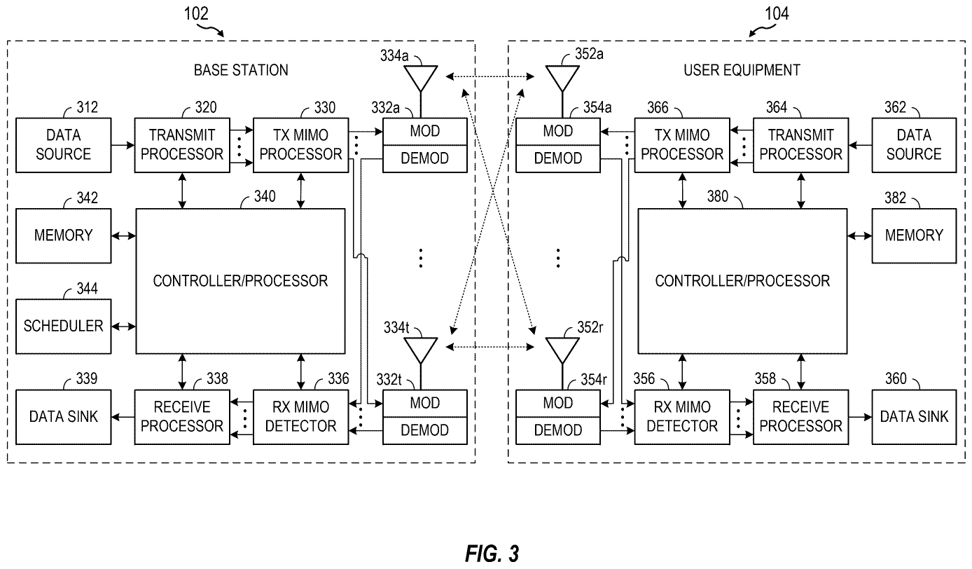

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

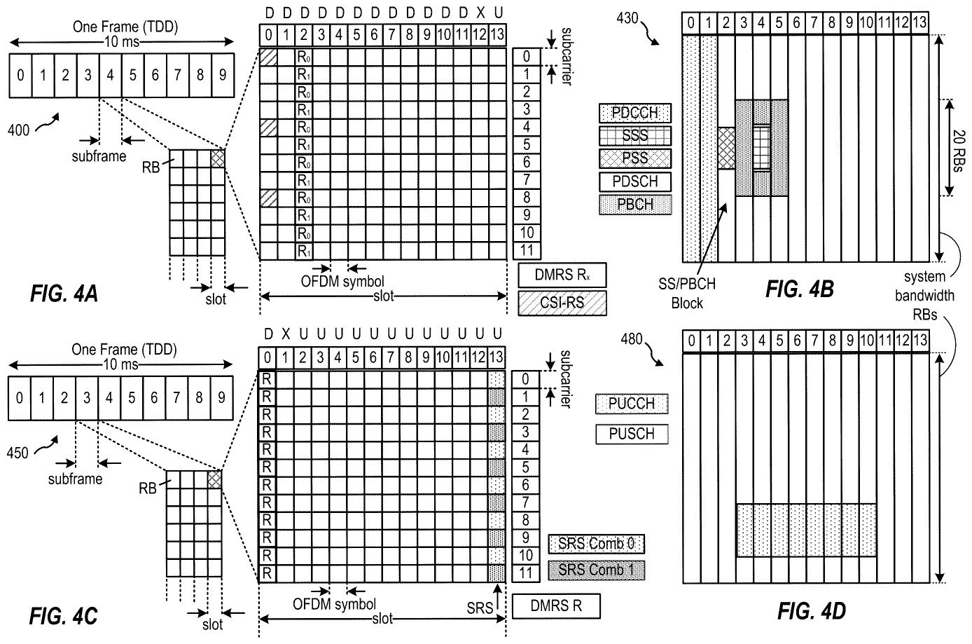

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of UL Mimo Procedures

As previously noted, NR generally supports two different uplink (UL) MIMO modes: codebook (CB) based on non-codebook (NCB) based.

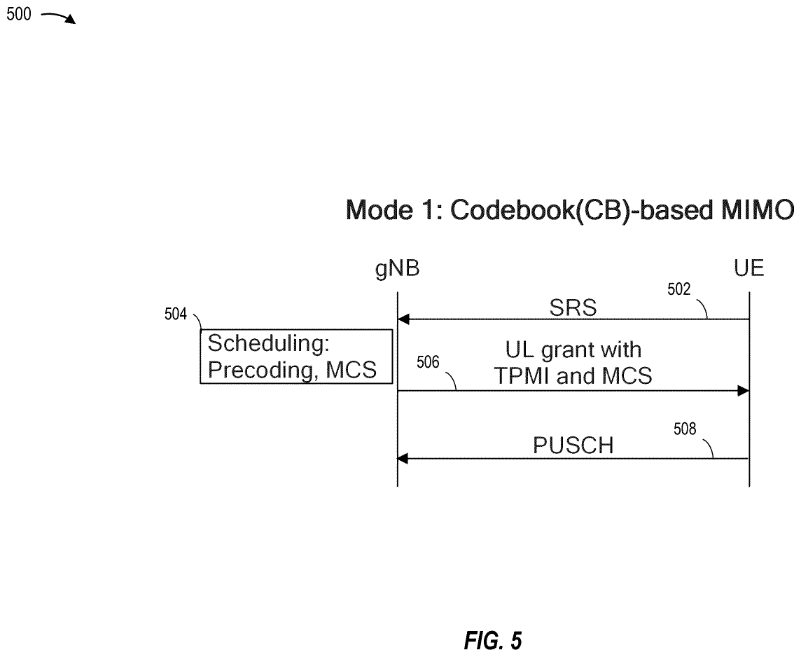

The call flow diagram 500 of FIG. 5 illustrates an example of CB based UL MIMO. As illustrated at 502, the UE may transmit sounding reference signals (SRS). A network entity (e.g., gNB) may determine precoding and a modulation and coding scheme (MCS) for the uplink transmission, based on the UE SRS, as indicated at 504.

The gNB may indicate the MCS and precoding as a Transmitted Precoding Matrix Indicator (TPMI) in the uplink grant, at 506. The UE may then transmit a physical uplink shared channel (PUSCH), as indicated at 508, based on the TPMI and MCS indicated in the grant.

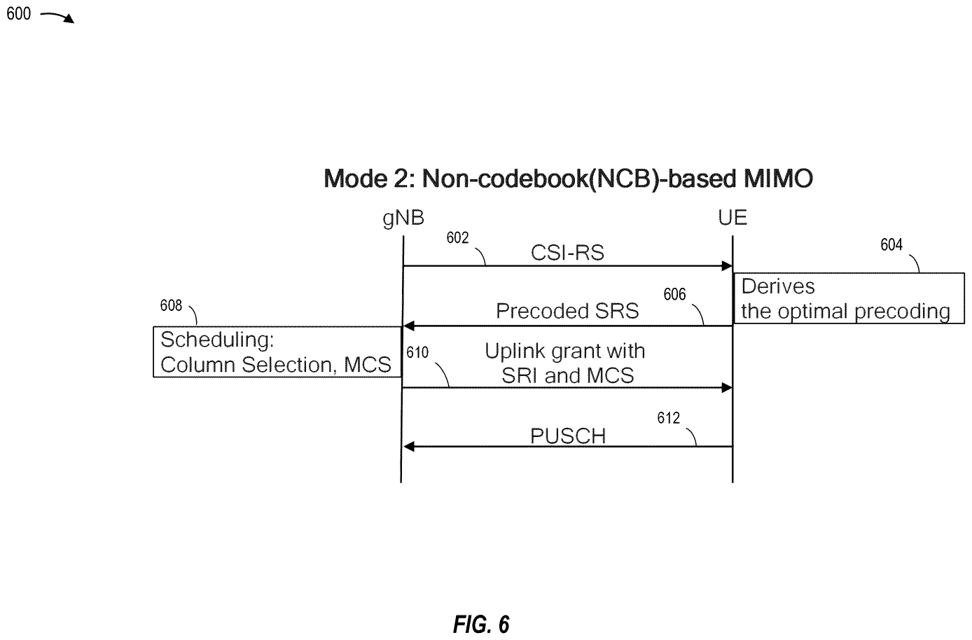

The call flow diagram 600 of FIG. 6 illustrates an example of NCB based UL MIMO. As illustrated at 602, the gNB may transmit CSI-RS. The UE derives/identifies optimal precoding based on the CSI-RS measurements, as indicated at 604. The UE then transmits SRS using the derived/identified precoding, as indicated at 606.

The gNB may perform column selection (e.g., effectively selecting a best SRS resource) and determine MCS, based on the SRS, ad indicated at 608. As indicated at 610, the gNB may then provide an indication of the SRS resource (via an SRS resource indicator-SRI) and MCS in the uplink grant. The UE may then transmit the PUSCH, as indicated at 612, based on the (precoding it used when transmitting SRS on the SRS resource indicated by the) SRI and MCS indicated in the grant.

As previously described, CB based MIMO is a relatively straightforward procedure. For example, the TPMI provided by the gNB generally represents a specific codebook entry by serving as an index that maps to a predefined precoding matrix within a codebook, enabling efficient signaling of the desired precoding for transmission. Unfortunately, CB based MIMO typically involves a relatively low resolution codebook. This makes it difficult for CB based MIMO to support subband precoding and provides limited flexibility for different UE antenna architectures. While NCB based MIMO typically has higher resolution and can support phase-continuous frequency-selective precoding, the NCB based procedure typically has a longer latency (due to the CSI-RS→SRS→grant sequence) and cannot support block-wise subband precoding.

### Aspects Related to UE-Centric Uplink Precoding in Cases of Multiple CSI-RS Resources

Aspects of the present disclosure, however, provide a UE-centric MIMO framework that may effectively achieve the best of both CB and NCB based UL MIMO modes. As will be described in greater detail below, the techniques proposed herein may be applied in scenarios where a UE is configured with multiple channel state information reference signal (CSI-RS) resources.

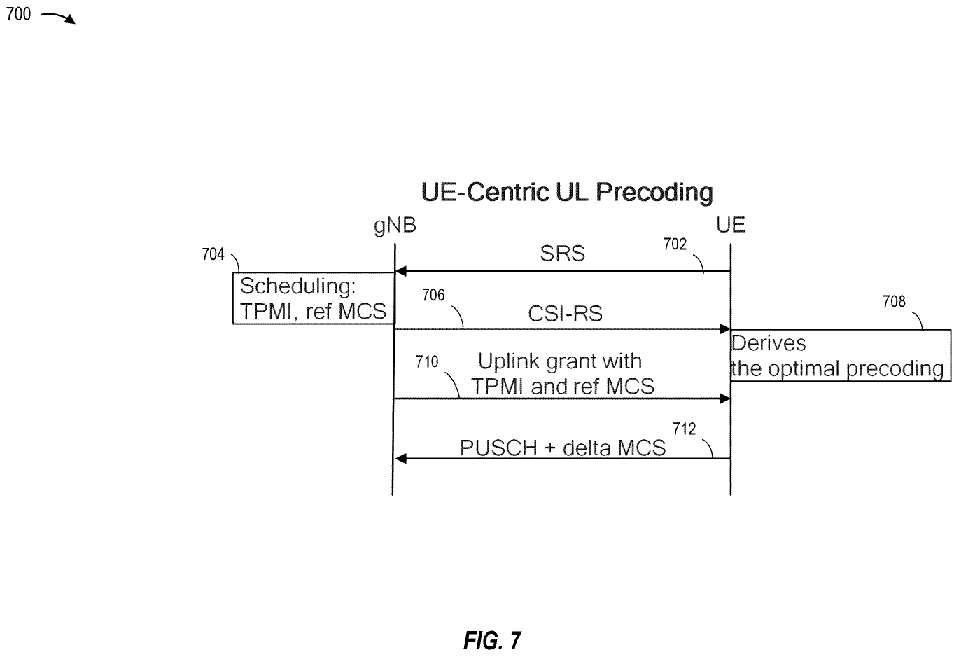

The call flow diagram 700 of FIG. 7 illustrates an example of UE-centric uplink precoding based UL MIMO.

As illustrated at 702, the UE transmits SRS. At 704, the gNB determines CB-based precoding (TPMI) and a reference MCS based on the SRS. At 706, the gNB transmits CSI-RS. At 708, the UE calculates (e.g., optimal/UE-centric) precoding based on the CSI-RS.

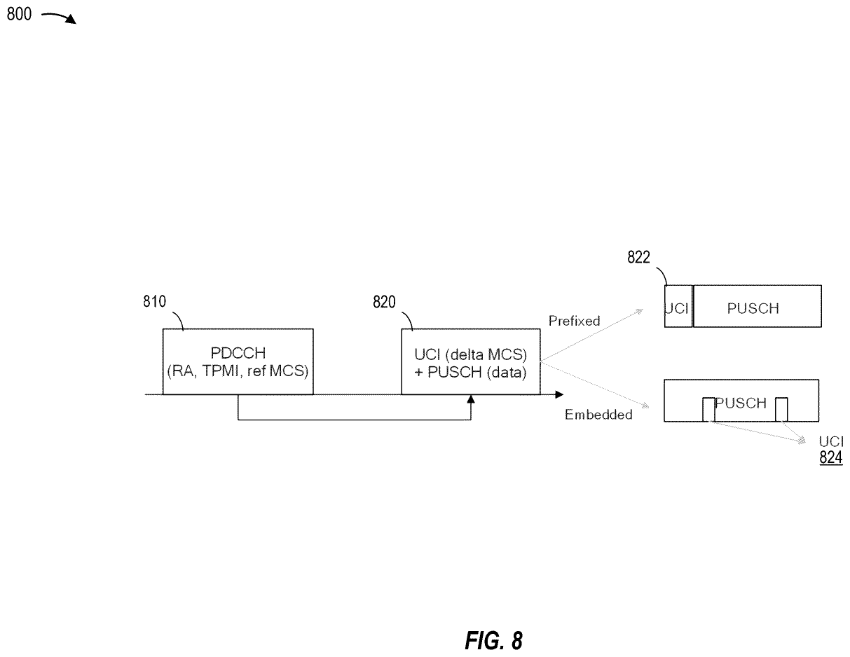

The gNB indicates the TPMI and reference MCS in the uplink grant, at 710. As illustrated at 810 in FIG. 8, the uplink grant may be conveyed via a physical downlink control channel (PDCCH).

At 712, the UE transmits PUSCH applying an MCS based on the reference MCS included in the UL grant and a differential (or “delta”) MCS. The UE may derive/identify the delta MCS based on a beamforming gain, which can be calculated as:

Gain_{dB}=10 log(∥HP_{UE}∥/∥HP_{gNB}∥),

where H represents the channel matrix, describing how a signal propagates from transmitter to receiver through the wireless medium, while P_{UE} and P_{gNB} represent UE-centric precoding based on the CSI-RS and gNB-indicated precoding based on TPMI, respectively (such that HPₓₓ indicates an effect of the channel after precoding).

As indicated at 712, the UE may also signal an indication of the delta MCS to the gNB. As indicated at 820 in diagram 800 of FIG. 8, in some cases, the indication of the delta MCS may be transmitted in uplink control information (UCI) together with PUSCH. The UCI may be included at the beginning (“prefixed”) of the PUSCH as indicated at 822 or may be embedded in the PUSCH as indicated at 824.

In cases where the delta MCS is conveyed in UCI with the PUSCH, the gNB may first decode the UCI. From this, the gNB can derive/identify the MCS used to transmit the PUSCH (e.g., as MCS =ref MCS +delta MCS). The gNB may then decode PUSCH based on this derived/identified MCS.

As demonstrated above, UE-centric MIMO may show promise in helping achieve high resolution and subband precoding gain, without the long latency associated with NCB-based MIMO due to its reliance on precoded SRS. Aspects of the present disclosure also propose techniques that may help apply the UE-centric MIMO procedure described above to scenarios where a UE is configured with multiple CSI-RS resources.

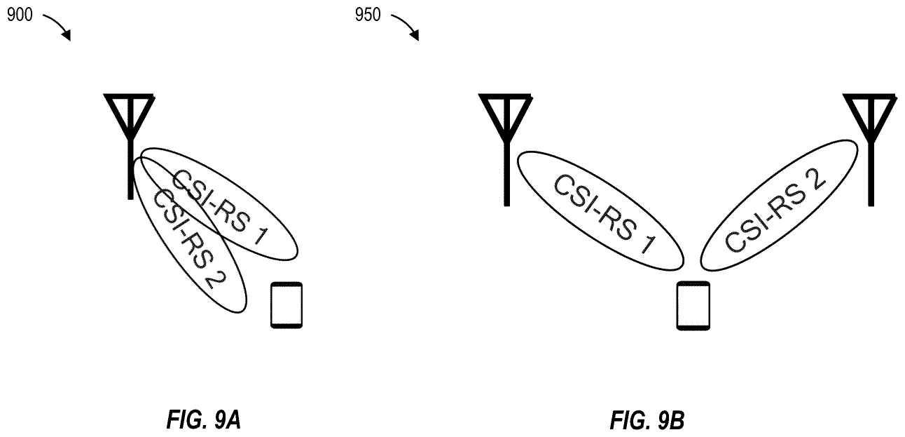

A UE may be configured with multiple CSI-RS resources, for example, for a gNB to support multi-beam or multi-TRP (Transmission and Reception Point) operation. In such cases, (reference signals on) the CSI-RS resources are transmitted for different beams or TRPs. For example, diagram 900 of FIG. 9A illustrates an example where CSI-RSs are transmitted from multiple beams on different CSI-RS resources (CSI-RS 1 and CSI-RS 2). Diagram 950 of FIG. 9B illustrates an example where CSI-RSs are transmitted on CSI-RS 1 and CSI-RS 2 from multiple TRPs.

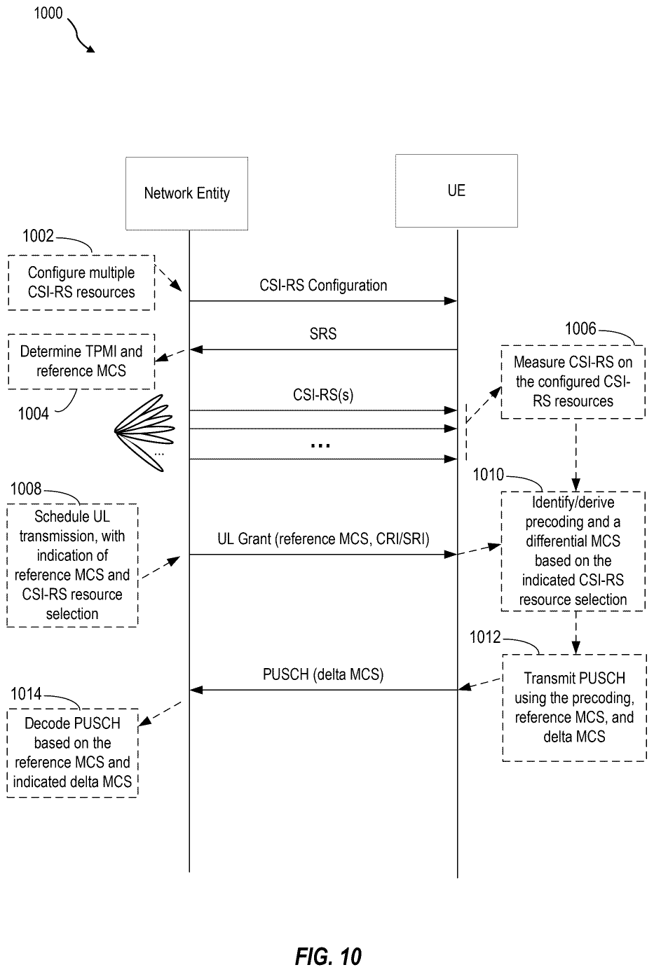

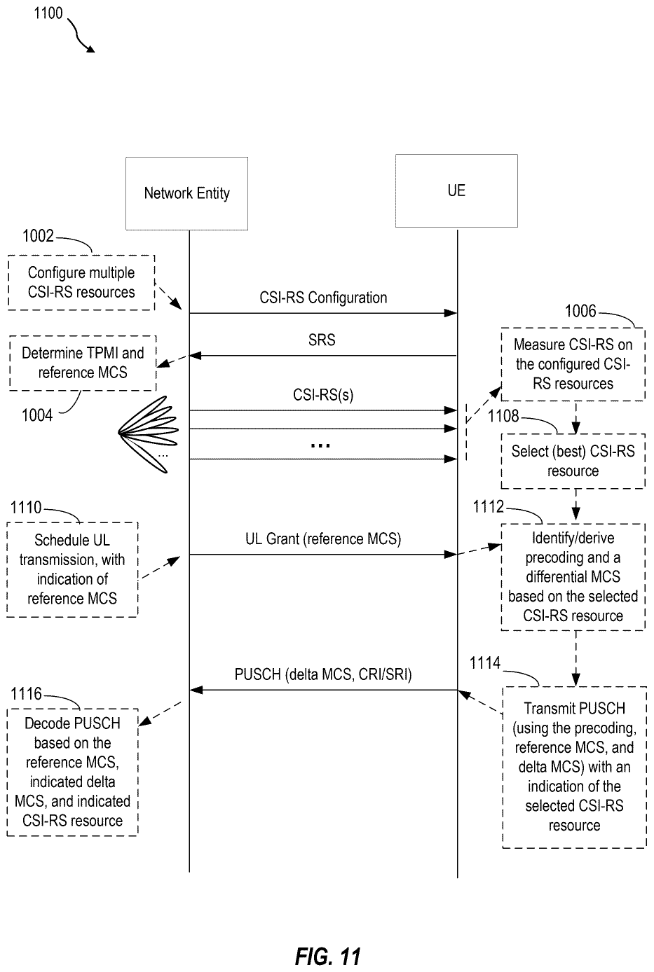

UE-centric uplink MIMO precoding in case of multiple CSI-RS resources, in accordance with aspects of the present disclosure may be understood with reference to call flow diagrams 1000 and 1100 of FIGS. 10 and 11. In some aspects, the UE shown in FIG. 10 and/or FIG. 11 may be an example of the UE 104 depicted and described with respect to FIGS. 1 and 3. In some aspects, the network entity shown in FIG. 10 and/or FIG. 11 may be an example of the BS 102 (e.g., a gNB) depicted and described with respect to FIGS. 1 and 3 or a disaggregated base station depicted and described with respect to FIG. 2.

As illustrated at 1002 of FIG. 10, the network entity may configure the UE with multiple CSI-RS resources. As illustrated, the UE transmits SRS and, at 1004, the network entity determines TPMI and a reference MCS based on the SRS

The network entity transmits CSI-RSs on the configured CSI-RS resources (e.g., for different beams or TRPs) and the UE measures the same, as indicated at 1006.

As indicated at 1008, the network entity schedules an UL transmission (e.g., PUSCH) via an uplink grant. As illustrated, the uplink grant may include an indication of the reference MCS and a CSI-RS resource selection. The uplink grant may be conveyed via downlink control information (DCI) in a PDCCH.

As indicated at 1010, the UE may derive/identify precoding (e.g., UE-centric uplink precoding matrix) and a corresponding differential (delta) MCS based on the CSI-RS resource selection indicated in the uplink grant.

As indicated at 1012, the UE then transmits PUSCH using the precoding, reference MCS, and delta MCS (e.g., using MCS=reference MCS plus delta MCS). As indicated at 1014, the network entity decodes the PUSCH based on the reference MCS and indicated delta MCS.

The delta MCS may be conveyed with the PUSCH (as UCI) or signaled separately. As noted above, if the delta MCS is conveyed in UCI with the PUSCH, the gNB may first decode the UCI. From this, the gNB can derive/identify the MCS used to transmit the PUSCH and then decode PUSCH based on this derived/identified MCS.

In the example shown in FIG. 10, the UE derives/identifies UE-centric uplink precoding matrix and the corresponding (delta) MCS based on the CSI-RS resource indicated by uplink grant (DCI).

In such cases, the UL grant may have a CRI (CSI-RS resource indicator/index) to indicate the CSI-RS resource (selected by the gNB) to the UE. The UE may derive/identify/apply UE-centric precoding and the corresponding delta MCS based on the CSI-RS resource indicated by the CRI in the uplink grant.

In other cases, the UL grant may have an SRI (SRS resource index) for the gNB to indicate the resource selection result to the UE. This approach is possible because each CSI-RS resource is typically associated to an SRS resource. Such association is typically configured via RRC signaling or MAC-CE.

In such cases, the UE may derive/identify the UE-centric uplink precoding matrix and the corresponding (delta) MCS based on the CSI-RS resource associated to the SRS resource indicated by the uplink grant (DCI).

In the example shown in FIG. 11, rather than the gNB selecting the CSI-RS resource, the UE may select one CSI-RS resource, as indicated at 1108. For example, the UE may select the best CSI-RS resource based on the CSI-RS measurements.

As indicated at 1110, because the CSI-RS resource selection is performed at the UE, the gNB includes the reference MCS but does not include a CSI-RS resource indication in the uplink grant.

As indicated at 1112, the UE derives/identifies the UE-centric uplink precoding matrix and the corresponding (delta) MCS based on the CSI-RS resource (selected by the UE at 1108).

As indicated at 1114, the UE may Transmit PUSCH (using the precoding, reference MCS, and delta MCS) with an indication of the selected CSI-RS resource. In some cases the UE may provide the indication via a CRI corresponding to the selected CSI-RS that is reported in UCI piggybacked to PUSCH. In other cases, the CRI may be conveyed as UCI in a separate physical uplink control channel (PUCCH).

As noted above, the selected CSI-RS resource is typically associated to an SRS resource. Therefore, rather than indicate the selected CSI-RS using CRI, the UE may indicate the selected CSI-RS using an SRI corresponding (associated with) the selected CSI-RS. As with the CRI example, the SRI may reported in UCI piggybacked to PUSCH (or in a separate PUCCH).

The UE-centric uplink MIMO precoding techniques proposed herein may result in performance gains, for example, in terms of increases in throughput (e.g., Mbits/sec). The increases may be achieved across a relatively large range of levels of signal to noise ratio (SNR). The performance gains may be an improvement, when compared to methods relying on non-connected (NC) precoding and fully-connected (FC) precoding. The performance gains achieved using the UE-centric approach proposed herein may increase with increased frequency of CSI-RS transmissions (e.g., at a cost of CSI-RS signaling overhead).

### Aspects Related to UE-Centric MIMO for Uplink Fallback Transmission

Certain systems (e.g., NR) may support various uplink transmission schemes for PUSCH: closed-loop MIMO transmission and open-loop single-layer transmission. Closed-loop MIMO (e.g., for PUSCH) is typically scheduled by a DCI format referred to as DCI format 0_1. Open-loop single-layer PUSCH transmission is typically scheduled by a DCI format referred to as DCI format 0_0.

A PUSCH scheduled via DCI format 0_0 may be referred to as a ‘fallback transmission’ as it may be used when MIMO is not available or feasible. For example, open-loop single-layer PUSCH transmission may be scheduled as a fallback when uplink CSI is absent or unreliable due to initial access, handover, or low-SNR SRS.

For the fallback transmission, there may be some ambiguity regarding how the single-layer is generated. For example, antenna port-to-layer mapping may be left up to UE implementation. Examples of fallback transmission schemes may include fixed beamforming, precoder cycling, or transparent small-delay CDD (SD-CDD).

In case of closed-loop MIMO transmission, it may be possible to apply UE-centric precoding as described above. In the case of fallback transmission, however, it may not be clear how to derive/identify the delta MCS.

Aspects of the present disclosure, however, provide various mechanisms that may help support UE-centric transmission for PUSCH when the UE is scheduled by fallback uplink grant (e.g., DCI format 0_0).

The proposed mechanisms may be understood by considering some observations. For example, a first observation is that when uplink and downlink (UL/DL) reciprocity holds (meaning channel conditions observed in one direction may be applicable in the other direction) and CSI-RS is available for UL precoding calculation, then the UE can apply UE-centric precoding for the single-layer fallback transmission.

A second observation is that, for the UE to calculate a delta MCS for UE-centric precoding, a specific precoding assumption may be used regarding gNB calculation of the reference MCS in the uplink grant. As noted above, delta MCS may be calculated as a function of beamforming gain (Gain_{dB}=10 log(∥HP_{UE}∥/∥HP_{gNB}∥). An assumption may be used to determine what precoding gain(s) to use in applying this equation.

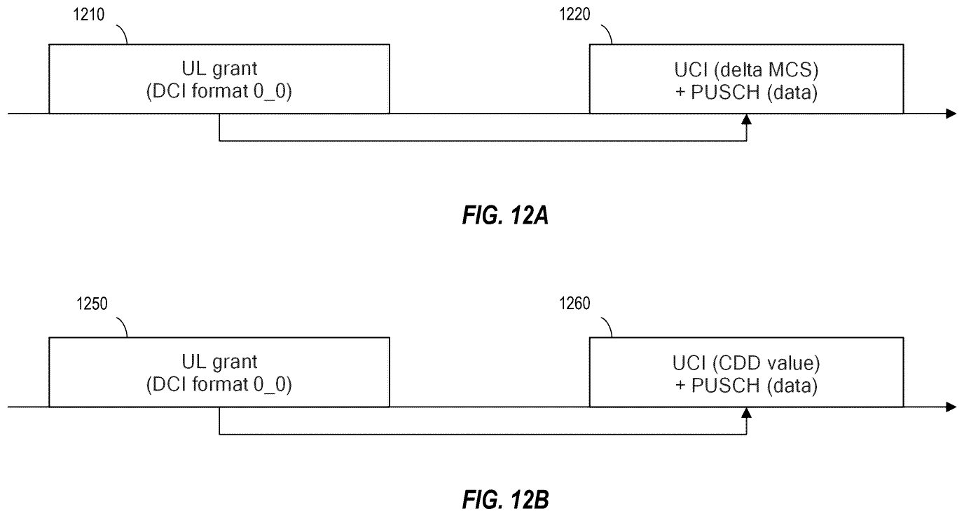

According to certain aspects of the present disclosure, when a UE is scheduled by fallback uplink grant (DCI format 0_0), for the scheduled PUSCH, a UE may apply UE-centric precoding and provide the gNB with an indication of the delta MCS. For example, as illustrated in FIG. 12A, when the UE is scheduled by a fallback uplink grant 1210 (DCI format 0_0), the UE may apply UE-centric precoding and an indication of the delta MCS may transmitted in UCI piggybacked on the PUSCH, as indicated at 1220.

In such cases, when the delta MCS is calculated, the UE may assume that a reference MCS included in the uplink grant is calculated based on a given precoding scheme. For example, the given precoding scheme may be assumed to be: 1) a random rank-1 precoding scheme; or 2) a small delay (SD) cyclic delay diversity (CDD) scheme (e.g., where a cyclic delay value (or CDD value) may separately signaled by RRC or MAC-CE).

In the case of fallback transmission, a fixed precoding may not be reliable for example, due to the lack of CSI measurements in case of initial access or handover. SD-CDD may be an effective transmit diversity (TxD) scheme to apply for fallback transmission.

CDD generally involves sending the same signal from multiple transmit antennas with different cyclic delays. In this manner, CDD may create frequency diversity by spreading the signal in frequency domains. CDD may be considered essentially equivalent to RE-level precoder cycling. SD-CDD refers to a variant of CDD that may be used in MIMO-OFDM systems, with a smaller delay value compared to cyclic prefix (CP) applied to the OFDM. SD-CDD may be beneficial in certain use cases for precoding and multi-antenna transmission.

Optimal CDD (SD-CDD) values may dependent on various factors, such as channel profile, MCS (SNR), and resource allocation. In case the CDD value is unknown to the UE, the performance may be sensitive to the choice of delay value. In such cases, the CDD value may be restricted to a very small value which may limit diversity gain. Performance degradation may be observed when the CDD value is unknown.

According to certain aspects of the present disclosure, a UE may provide an indication of a CDD value applied when scheduled by a fallback uplink grant. For example, as illustrated in FIG. 12B, when the UE is scheduled by a fallback uplink grant 1250 (DCI format 0_0), the UE may apply SD-CDD to the PUSCH transmission and the applied CDD value may transmitted in UCI piggybacked on the PUSCH, as indicated at 1260.

According to certain aspects, when a UE is scheduled by fallback uplink grant (DCI format 0_0), the UE may determine the PUSCH transmission scheme to apply. For example, the UE may choose between UE-centric precoding and SD-CDD. In such cases, the UE may provide the gNB an indication of the transmission scheme selected and used, via a transmission scheme indicator (TSI).

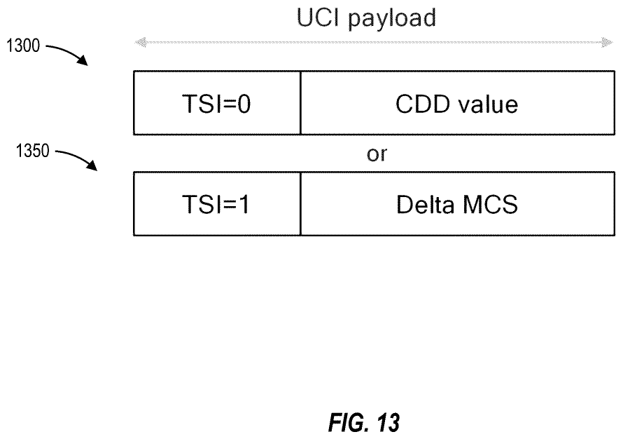

As illustrated in FIG. 13, the TSI may be conveyed via UCI, transmitted together with the PUSCH. The UCI may include the transmission scheme indicator (TSI) and the relevant parameter.

For example, as illustrated at 1300, a first value of TSI (e.g., TSI=0) may indicate that SD-CDD is applied and the remaining UCI payload may be used to indicate the corresponding CDD value. The gNB can then decode the UCI, determine that SD-CDD was applied and (using the indicated CDD value), decode PUSCH accordingly.

A second value of TSI (e.g., TSI=1) may indicate that UE-centric precoding is applied and the remaining UCI payload may be used to indicate the corresponding delta MCS. The gNB can then decode the UCI, determine that UE-centric precoding was applied and (using the indicated delta MCS), decode PUSCH accordingly

According to certain aspects, a CDD value and delta MCS may be jointly coded in UCI and transmitted together with PUSCH. For example, one part of UCI may indicate CDD values, while another part may indicate delta MCS values. For example, UCI may indicate N states with ┌ log₂N┐ bits, where M states indicate CDD values and (N−M) states indicate delta MCS values.

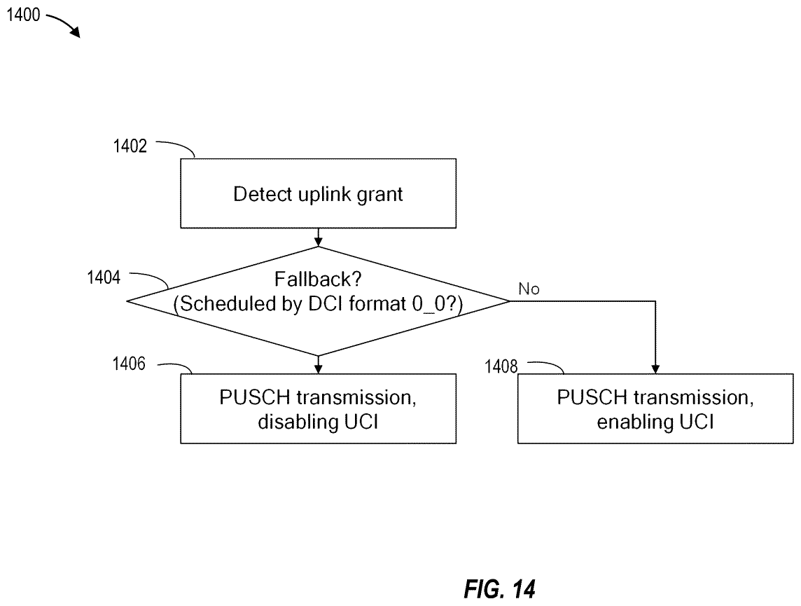

According to certain aspects, a fallback transmission scheme may not be defined. In such cases, UCI (piggybacked in PUSCH) may be disabled when the PUSCH is scheduled by a fallback uplink grant (DCI format 0_0). An example of this approach is shown in the flow diagram 1400 of FIG. 14, if an uplink grant (e.g., detected at 1402) is for fallback transmission (as determined at 1404), UCI is disabled for (e.g., not included in) the scheduled PUSCH transmission. On the other hand, if the uplink grant is not for fallback transmission, UCI is enabled for (e.g., included in) the scheduled PUSCH transmission.

### Example Operations

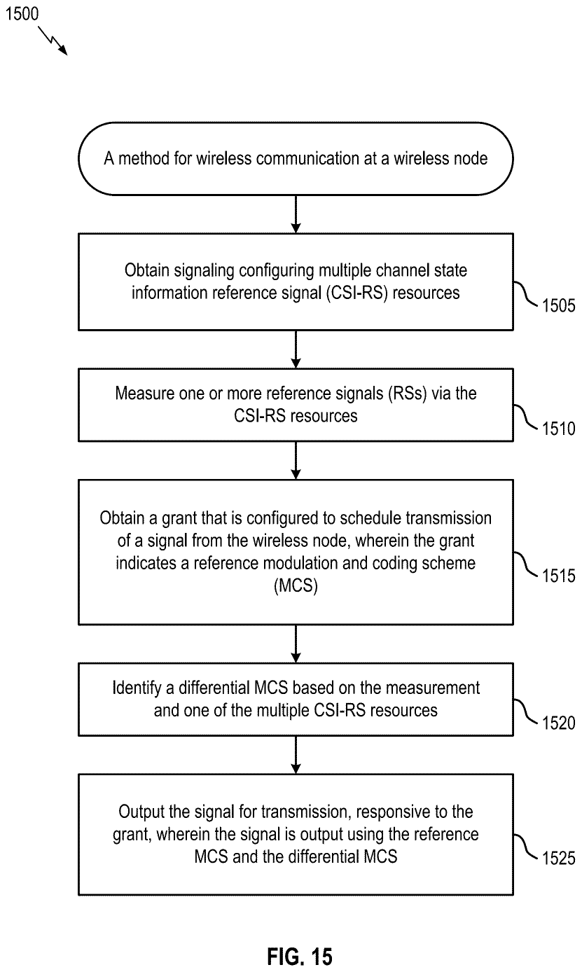

FIG. 15 shows an example of a method 1500 of wireless communication at a wireless node, such as a UE 104 of FIGS. 1 and 3.

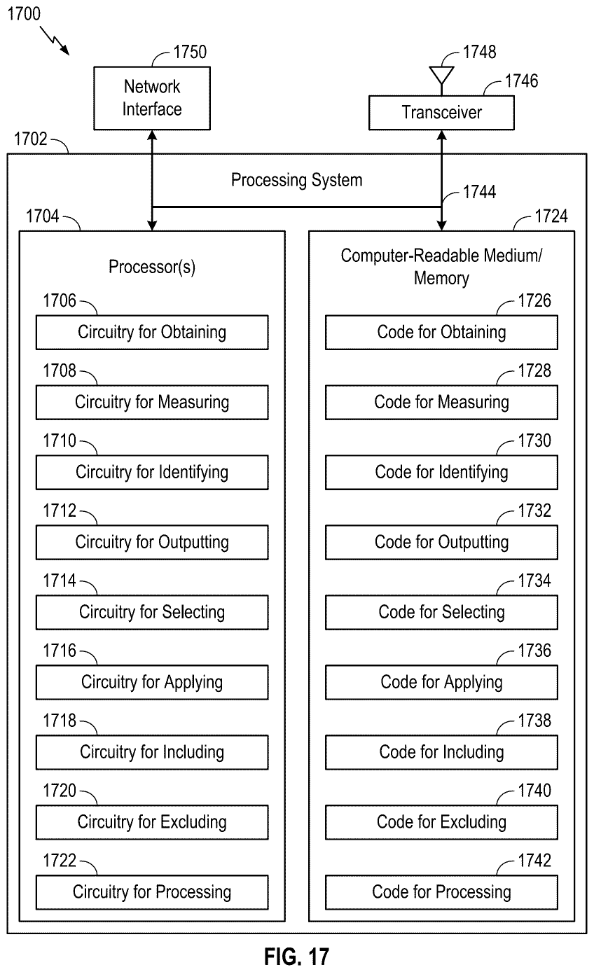

Method 1500 begins at step 1505 with obtaining signaling configuring multiple channel state information reference signal (CSI-RS) resources. In some cases, the operations of this step refer to, or may be performed by, circuitry for obtaining and/or code for obtaining as described with reference to FIG. 17.

Method 1500 then proceeds to step 1510 with measuring one or more reference signals (RSs) via the CSI-RS resources. In some cases, the operations of this step refer to, or may be performed by, circuitry for measuring and/or code for measuring as described with reference to FIG. 17.

Method 1500 then proceeds to step 1515 with obtaining a grant that is configured to schedule transmission of a signal from the wireless node, wherein the grant indicates a reference modulation and coding scheme (MCS). In some cases, the operations of this step refer to, or may be performed by, circuitry for obtaining and/or code for obtaining as described with reference to FIG. 17.

Method 1500 then proceeds to step 1520 with identifying a differential MCS based on the measurement and one of the multiple CSI-RS resources. In some cases, the operations of this step refer to, or may be performed by, circuitry for identifying and/or code for identifying as described with reference to FIG. 17.

Method 1500 then proceeds to step 1525 with outputting the signal for transmission, responsive to the grant, wherein the signal is output using the reference MCS and the differential MCS. In some cases, the operations of this step refer to, or may be performed by, circuitry for outputting and/or code for outputting as described with reference to FIG. 17.

In some aspects, the signal is output for transmission as a multiple-input multiple-output (MIMO) signal; and the method further comprises applying a precoding matrix when outputting the MIMO signal for transmission, wherein the precoding matrix is based on the measurement and the one CSI-RS resource.

In some aspects, the method 1500 further includes outputting an indication of the differential MCS via control information conveyed with the signal. In some cases, the operations of this step refer to, or may be performed by, circuitry for outputting and/or code for outputting as described with reference to FIG. 17.

In some aspects, the grant also indicates the one CSI-RS resource via a CSI-RS resource indicator (CRI).

In some aspects, the grant indicates the one CSI-RS resource via a sounding reference signal (SRS) resource indicator (SRI) that also indicates an SRS resource associated with the one CSI-RS resource.

In some aspects, the method 1500 further includes selecting the one CSI-RS resource based on the measurement. In some cases, the operations of this step refer to, or may be performed by, circuitry for selecting and/or code for selecting as described with reference to FIG. 17.

In some aspects, the method 1500 further includes outputting an indication of the one CSI-RS resource. In some cases, the operations of this step refer to, or may be performed by, circuitry for outputting and/or code for outputting as described with reference to FIG. 17.

In some aspects, the one CSI-RS resource is indicated via at least one of: control information conveyed with the signal or a separate signal; a CSI-RS resource indicator (CRI); or a sounding reference signal (SRS) resource indicator (SRI) that also indicates an SRS resource associated with the reference CSI-RS resource.

In some aspects, the signal is output for transmission as a single layer signal.

In some aspects, the differential MCS is derived/identified based on an assumption regarding a precoding scheme on which calculation of the reference MCS was based.

In some aspects, the assumption is that the precoding scheme involved a random precoding scheme or a small delay cyclic delay diversity (SD-CDD) scheme.

In some aspects, the method 1500 further includes applying a small delay cyclic delay diversity (SD-CDD) value when outputting the signal for transmission. In some cases, the operations of this step refer to, or may be performed by, circuitry for applying and/or code for applying as described with reference to FIG. 17.

In some aspects, the method 1500 further includes outputting an indication of the SD-CDD value. In some cases, the operations of this step refer to, or may be performed by, circuitry for outputting and/or code for outputting as described with reference to FIG. 17.

In some aspects, the method 1500 further includes selecting a transmission scheme to apply when outputting the signal for transmission. In some cases, the operations of this step refer to, or may be performed by, circuitry for selecting and/or code for selecting as described with reference to FIG. 17.

In some aspects, the method 1500 further includes including an indication of the selected transmission scheme as control information with the signal. In some cases, the operations of this step refer to, or may be performed by, circuitry for including and/or code for including as described with reference to FIG. 17.

In some aspects, the method 1500 further includes including control information with the signal when the signal is output for transmission as a multiple-input multiple-output (MIMO) signal. In some cases, the operations of this step refer to, or may be performed by, circuitry for including and/or code for including as described with reference to FIG. 17.

In some aspects, the method 1500 further includes excluding control information from the signal when the signal is output for transmission as a single layer signal. In some cases, the operations of this step refer to, or may be performed by, circuitry for excluding and/or code for excluding as described with reference to FIG. 17.

In one aspect, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative steps are possible consistent with this disclosure.

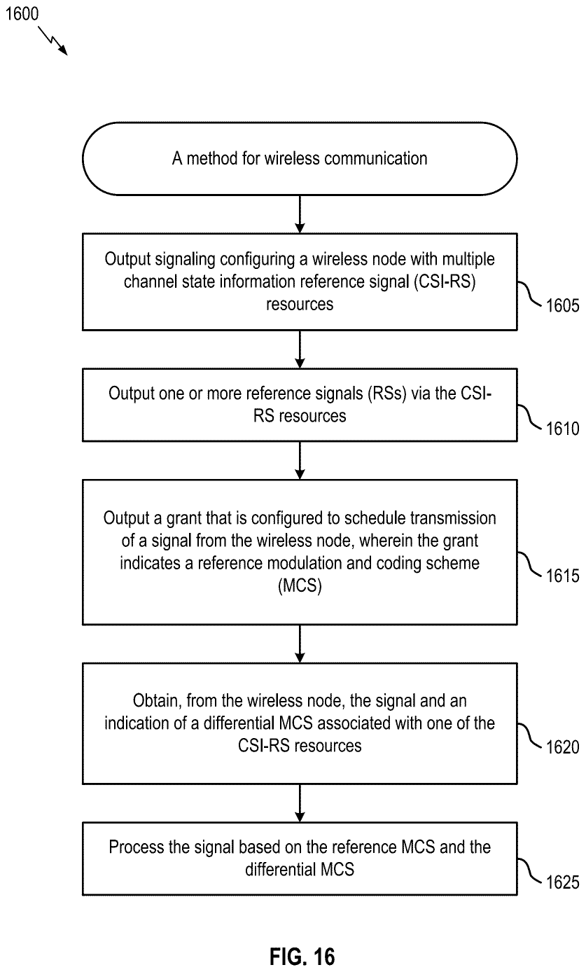

FIG. 16 shows an example of a method 1600 of wireless communication at a wireless node, such as a BS 102 of FIGS. 1 and 3, or a disaggregated base station as discussed with respect to FIG. 2.

Method 1600 begins at step 1605 with outputting signaling configuring a wireless node with multiple channel state information reference signal (CSI-RS) resources. In some cases, the operations of this step refer to, or may be performed by, circuitry for outputting and/or code for outputting as described with reference to FIG. 17.

Method 1600 then proceeds to step 1610 with outputting one or more reference signals (RSs) via the CSI-RS resources. In some cases, the operations of this step refer to, or may be performed by, circuitry for outputting and/or code for outputting as described with reference to FIG. 17.

Method 1600 then proceeds to step 1615 with outputting a grant that is configured to schedule transmission of a signal from the wireless node, wherein the grant indicates a reference modulation and coding scheme (MCS). In some cases, the operations of this step refer to, or may be performed by, circuitry for outputting and/or code for outputting as described with reference to FIG. 17.

Method 1600 then proceeds to step 1620 with obtaining, from the wireless node, the signal and an indication of a differential MCS associated with one of the CSI-RS resources. In some cases, the operations of this step refer to, or may be performed by, circuitry for obtaining and/or code for obtaining as described with reference to FIG. 17.

Method 1600 then proceeds to step 1625 with processing the signal based on the reference MCS and the differential MCS. In some cases, the operations of this step refer to, or may be performed by, circuitry for processing and/or code for processing as described with reference to FIG. 17.

In some aspects, the signal is obtained as a multiple-input multiple-output (MIMO) signal; and the indication of the differential MCS is obtained via control information conveyed with the signal.

In some aspects, the grant also indicates the one CSI-RS resource via a CSI-RS resource indicator (CRI).

In some aspects, the grant indicates the one CSI-RS resource via a sounding reference signal (SRS) resource indicator (SRI) that also indicates an SRS resource associated with the one CSI-RS resource.

In some aspects, the method 1600 further includes obtaining, from the wireless node, an indication of the one CSI-RS resource. In some cases, the operations of this step refer to, or may be performed by, circuitry for obtaining and/or code for obtaining as described with reference to FIG. 17.

In some aspects, the one CSI-RS resource is indicated via at least one of: control information conveyed with the signal or a separate signal; a CSI-RS resource indicator (CRI); or a sounding reference signal (SRS) resource indicator (SRI) that also indicates an SRS resource associated with the reference CSI-RS resource.

In some aspects, the signal is obtained as a single layer signal.

In some aspects, the method 1600 further includes obtaining, from the wireless node, an indication of a small delay cyclic delay diversity (SD-CDD) value. In some cases, the operations of this step refer to, or may be performed by, circuitry for obtaining and/or code for obtaining as described with reference to FIG. 17.

In some aspects, the method 1600 further includes processing the signal based on the SD-CDD value. In some cases, the operations of this step refer to, or may be performed by, circuitry for processing and/or code for processing as described with reference to FIG. 17.

In some aspects, the method 1600 further includes obtaining an indication of a transmission scheme as control information conveyed with the signal. In some cases, the operations of this step refer to, or may be performed by, circuitry for obtaining and/or code for obtaining as described with reference to FIG. 17.

In some aspects, the method 1600 further includes processing the signal based on the indicated transmission scheme. In some cases, the operations of this step refer to, or may be performed by, circuitry for processing and/or code for processing as described with reference to FIG. 17.

In one aspect, method 1600, or any aspect related to it, may be performed by an apparatus, such as communications device 1700 of FIG. 17, which includes various components operable, configured, or adapted to perform the method 1600. Communications device 1700 is described below in further detail.

Note that FIG. 16 is just one example of a method, and other methods including fewer, additional, or alternative steps are possible consistent with this disclosure.

### Example Communications Device(s)

FIG. 17 depicts aspects of an example communications device 1700. In some aspects, communications device 1700 is a user equipment, such as UE 104 described above with respect to FIGS. 1 and 3. In some aspects, communications device 1700 is a network entity, such as BS 102 of FIGS. 1 and 3, or a disaggregated base station as discussed with respect to FIG. 2.

The communications device 1700 includes a processing system 1702 coupled to the transceiver 1746 (e.g., a transmitter and/or a receiver). In some aspects (e.g., when communications device 1700 is a network entity), processing system 1702 may be coupled to a network interface 1750 that is configured to obtain and send signals for the communications device 1700 via communication link(s), such as a backhaul link, midhaul link, and/or fronthaul link as described herein, such as with respect to FIG. 2. The transceiver 1746 is configured to transmit and receive signals for the communications device 1700 via the antenna 1748, such as the various signals as described herein. The processing system 1702 may be configured to perform processing functions for the communications device 1700, including processing signals received and/or to be transmitted by the communications device 1700.

The processing system 1702 includes one or more processors 1704. In various aspects, the one or more processors 1704 may be representative of one or more of receive processor 358, transmit processor 364, TX MIMO processor 366, and/or controller/processor 380, as described with respect to FIG. 3. In various aspects, one or more processors 1704 may be representative of one or more of receive processor 338, transmit processor 320, TX MIMO processor 330, and/or controller/processor 340, as described with respect to FIG. 3. The one or more processors 1704 are coupled to a computer-readable medium/memory 1724 via a bus 1744. In certain aspects, the computer-readable medium/memory 1724 is configured to store instructions (e.g., computer-executable code) that when executed by the one or more processors 1704, cause the one or more processors 1704 to perform the method 1500 described with respect to FIG. 15, or any aspect related to it; and the method 1600 described with respect to FIG. 16, or any aspect related to it. Note that reference to a processor performing a function of communications device 1700 may include one or more processors 1704 performing that function of communications device 1700.

In the depicted example, computer-readable medium/memory 1724 stores code (e.g., executable instructions), such as code for obtaining 1726, code for measuring 1728, code for identifying 1730, code for outputting 1732, code for selecting 1734, code for applying 1736, code for including 1738, code for excluding 1740, and code for processing 1742. Processing of the code for obtaining 1726, code for measuring 1728, code for identifying 1730, code for outputting 1732, code for selecting 1734, code for applying 1736, code for including 1738, code for excluding 1740, and code for processing 1742 may cause the communications device 1700 to perform the method 1500 described with respect to FIG. 15, or any aspect related to it; and the method 1600 described with respect to FIG. 16, or any aspect related to it.

The one or more processors 1704 include circuitry configured to implement (e.g., execute) the code stored in the computer-readable medium/memory 1724, including circuitry for obtaining 1706, circuitry for measuring 1708, circuitry for identifying 1710, circuitry for outputting 1712, circuitry for selecting 1714, circuitry for applying 1716, circuitry for including 1718, circuitry for excluding 1720, and circuitry for processing 1722. Processing with circuitry for obtaining 1706, circuitry for measuring 1708, circuitry for identifying 1710, circuitry for outputting 1712, circuitry for selecting 1714, circuitry for applying 1716, circuitry for including 1718, circuitry for excluding 1720, and circuitry for processing 1722 may cause the communications device 1700 to perform the method 1500 described with respect to FIG. 15, or any aspect related to it; and the method 1600 described with respect to FIG. 16, or any aspect related to it.

Various components of the communications device 1700 may provide means for performing the method 1500 described with respect to FIG. 15, or any aspect related to it; and the method 1600 described with respect to FIG. 16, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1746 and the antenna 1748 of the communications device 1700 in FIG. 17. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1746 and the antenna 1748 of the communications device 1700 in FIG. 17.

### Example Clauses

Implementation examples are described in the following numbered clauses:

Clause 1: A method for wireless communication at a wireless node, comprising: obtaining signaling configuring multiple channel state information reference signal (CSI-RS) resources; measuring one or more reference signals (RSs) via the CSI-RS resources; obtaining a grant that is configured to schedule transmission of a signal from the wireless node, wherein the grant indicates a reference modulation and coding scheme (MCS); identifying a differential MCS based on the measurement and one of the multiple CSI-RS resources; and outputting the signal for transmission, responsive to the grant, wherein the signal is output using the reference MCS and the differential MCS.

Clause 2: The method of Clause 1, wherein: the signal is output for transmission as a multiple-input multiple-output (MIMO) signal; and the method further comprises applying a precoding matrix when outputting the MIMO signal for transmission, wherein the precoding matrix is based on the measurement and the one CSI-RS resource.

Clause 3: The method of any one of Clauses 1-2, further comprising outputting an indication of the differential MCS via control information conveyed with the signal.

Clause 4: The method of any one of Clauses 1-3, wherein the grant also indicates the one CSI-RS resource via a CSI-RS resource indicator (CRI).

Clause 5: The method of any one of Clauses 1-4, wherein the grant indicates the one CSI-RS resource via a sounding reference signal (SRS) resource indicator (SRI) that also indicates an SRS resource associated with the one CSI-RS resource.

Clause 6: The method of any one of Clauses 1-5, further comprising: selecting the one CSI-RS resource based on the measurement; and outputting an indication of the one CSI-RS resource.

Clause 7: The method of Clause 6, wherein the one CSI-RS resource is indicated via at least one of: control information conveyed with the signal or a separate signal; a CSI-RS resource indicator (CRI); or a sounding reference signal (SRS) resource indicator (SRI) that also indicates an SRS resource associated with the reference CSI-RS resource.

Clause 8: The method of any one of Clauses 1-7, wherein the signal is output for transmission as a single layer signal.

Clause 9: The method of Clause 8, wherein the differential MCS is identified based on an assumption regarding a precoding scheme on which calculation of the reference MCS was based.

Clause 10: The method of Clause 9, wherein the assumption is that the precoding scheme involved a random precoding scheme or a small delay cyclic delay diversity (SD-CDD) scheme.

Clause 11: The method of Clause 8, further comprising: applying a small delay cyclic delay diversity (SD-CDD) value when outputting the signal for transmission; and outputting an indication of the SD-CDD value.

Clause 12: The method of Clause 8, further comprising: selecting a transmission scheme to apply when outputting the signal for transmission; and including an indication of the selected transmission scheme as control information with the signal.

Clause 13: The method of any one of Clauses 1-12, further comprising: including control information with the signal when the signal is output for transmission as a multiple-input multiple-output (MIMO) signal; and excluding control information from the signal when the signal is output for transmission as a single layer signal.

Clause 14: A method for wireless communication, comprising: outputting signaling configuring a wireless node with multiple channel state information reference signal (CSI-RS) resources; outputting one or more reference signals (RSs) via the CSI-RS resources; outputting a grant that is configured to schedule transmission of a signal from the wireless node, wherein the grant indicates a reference modulation and coding scheme (MCS); obtaining, from the wireless node, the signal and an indication of a differential MCS associated with one of the CSI-RS resources; and processing the signal based on the reference MCS and the differential MCS.

Clause 15: The method of Clause 14, wherein: the signal is obtained as a multiple-input multiple-output (MIMO) signal; and the indication of the differential MCS is obtained via control information conveyed with the signal.

Clause 16: The method of any one of Clauses 14-15, wherein the grant also indicates the one CSI-RS resource via a CSI-RS resource indicator (CRI).

Clause 17: The method of any one of Clauses 14-16, wherein the grant indicates the one CSI-RS resource via a sounding reference signal (SRS) resource indicator (SRI) that also indicates an SRS resource associated with the one CSI-RS resource.

Clause 18: The method of any one of Clauses 14-17, further comprising: obtaining, from the wireless node, an indication of the one CSI-RS resource.

Clause 19: The method of Clause 18, wherein the one CSI-RS resource is indicated via at least one of: control information conveyed with the signal or a separate signal; a CSI-RS resource indicator (CRI); or a sounding reference signal (SRS) resource indicator (SRI) that also indicates an SRS resource associated with the reference CSI-RS resource.

Clause 20: The method of any one of Clauses 14-19, wherein the signal is obtained as a single layer signal.

Clause 21: The method of Clause 20, further comprising: obtaining, from the wireless node, an indication of a small delay cyclic delay diversity (SD-CDD) value; and processing the signal based on the SD-CDD value.

Clause 22: The method of Clause 20, further comprising: obtaining an indication of a transmission scheme as control information conveyed with the signal; and processing the signal based on the indicated transmission scheme.

Clause 23: An apparatus, comprising: at least one memory comprising executable instructions; and at least one processor configured to execute the executable instructions and cause the apparatus to perform a method in accordance with any combination of Clauses 1-22.

Clause 24: An apparatus, comprising means for performing a method in accordance with any combination of Clauses 1-22.

Clause 25: A non-transitory computer-readable medium comprising executable instructions that, when executed by at least one processor of an apparatus, cause the apparatus to perform a method in accordance with any combination of Clauses 1-22.

Clause 26: A computer program product embodied on a computer-readable storage medium comprising code for performing a method in accordance with any combination of Clauses 1-22.

Clause 27: A wireless node (e.g., a user equipment (UE)), comprising: at least one transceiver, at least one memory comprising instructions; and at least one processor configured to execute the instructions and cause the apparatus to perform a method in accordance with any combination of Clauses 1-13, wherein the at least one transceiver configured to receive the signaling.

Clause 28: A wireless node (e.g., a network entity), comprising: at least one transceiver, at least one memory comprising instructions; and at least one processor configured to execute the instructions and cause the apparatus to perform a method in accordance with any combination of Clauses 14-22, wherein the at least one transceiver configured to transmit the signaling.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

Means for obtaining, means for measuring, means for identifying, means for outputting, means for selecting, means for applying, means for including, means for excluding, and means for processing may comprise one or more processors, such as one or more of the processors described above with reference to FIG. 17.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, identifying, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
at least one memory comprising computer-executable instructions; and
one or more processors configured to execute the computer-executable instructions and cause the apparatus to:
obtain signaling configuring multiple channel state information reference signal (CSI-RS) resources;
measure one or more reference signals (RSs) via the CSI-RS resources;
obtain a grant that is configured to schedule transmission of a signal from the apparatus, wherein the grant indicates a reference modulation and coding scheme (MCS);
identify a differential MCS based on the measurement and one of the multiple CSI-RS resources; and
output the signal for transmission, responsive to the grant, wherein the signal is output using the reference MCS and the differential MCS.

2. The apparatus of claim 1, wherein:
the signal is output for transmission as a multiple-input multiple-output (MIMO) signal; and
the one or more processors are further configured to cause the apparatus to:
apply a precoding matrix when outputting the MIMO signal for transmission, wherein the precoding matrix is based on the measurement and the one CSI-RS resource.

3. The apparatus of claim 1, wherein the one or more processors are further configured to cause the apparatus to output an indication of the differential MCS via control information conveyed with the signal.

4. The apparatus of claim 1, wherein the grant also indicates the one CSI-RS resource via a CSI-RS resource indicator (CRI).

5. The apparatus of claim 1, wherein the grant indicates the one CSI-RS resource via a sounding reference signal (SRS) resource indicator (SRI) that also indicates an SRS resource associated with the one CSI-RS resource.

6. The apparatus of claim 1, wherein the one or more processors are further configured to execute the computer-executable instructions and cause the apparatus to:
select the one CSI-RS resource based on the measurement; and
output an indication of the one CSI-RS resource.

7. The apparatus of claim 6, wherein the one CSI-RS resource is indicated via at least one of:
control information conveyed with the signal or a separate signal;
a CSI-RS resource indicator (CRI); or
a sounding reference signal (SRS) resource indicator (SRI) that also indicates an SRS resource associated with the reference CSI-RS resource.

8. The apparatus of claim 1, wherein the signal is output for transmission as a single layer signal.

9. The apparatus of claim 8, wherein the differential MCS is identified based on an assumption regarding a precoding scheme on which calculation of the reference MCS was based.

10. The apparatus of claim 9, wherein the assumption is that the precoding scheme involved a random precoding scheme or a small delay cyclic delay diversity (SD-CDD) scheme.

11. The apparatus of claim 8, wherein the one or more processors are further configured to cause the apparatus to:
apply a small delay cyclic delay diversity (SD-CDD) value when outputting the signal for transmission; and
output an indication of the SD-CDD value.

12. The apparatus of claim 8, wherein the one or more processors are further configured to cause the apparatus to:
select a transmission scheme to apply when outputting the signal for transmission; and
include an indication of the selected transmission scheme as control information with the signal.

13. The apparatus of claim 1, wherein the one or more processors are further configured to cause the apparatus to:
include control information with the signal when the signal is output for transmission as a multiple-input multiple-output (MIMO) signal; or
exclude control information from the signal when the signal is output for transmission as a single layer signal.

14. The apparatus of claim 1, further comprising at least one transceiver configured to receive the signaling, wherein the apparatus is configured as a user equipment (UE).

15. An apparatus for wireless communication, comprising:
at least one memory comprising computer-executable instructions; and
one or more processors configured to execute the computer-executable instructions and cause the apparatus to:
output signaling configuring a wireless node with multiple channel state information reference signal (CSI-RS) resources;
output one or more reference signals (RSs) via the CSI-RS resources;
output a grant that is configured to schedule transmission of a signal from the wireless node, wherein the grant indicates a reference modulation and coding scheme (MCS);
obtain, from the wireless node, the signal and an indication of a differential MCS associated with one of the CSI-RS resources; and
process the signal based on the reference MCS and the differential MCS.

16. The apparatus of claim 15, wherein:
the signal is obtained as a multiple-input multiple-output (MIMO) signal; and
the indication of the differential MCS is obtained via control information conveyed with the signal.

17. The apparatus of claim 15, wherein the grant also indicates the one CSI-RS resource via a CSI-RS resource indicator (CRI).

18. The apparatus of claim 15, wherein the grant indicates the one CSI-RS resource via a sounding reference signal (SRS) resource indicator (SRI) that also indicates an SRS resource associated with the one CSI-RS resource.

19. The apparatus of claim 15, further comprising at least one transceiver configured to transmit the signaling, wherein the apparatus is configured as a network entity.

20. A method for wireless communication at a wireless node, comprising:
obtaining signaling configuring multiple channel state information reference signal (CSI-RS) resources;
measuring one or more reference signals (RSs) via the CSI-RS resources;
obtaining a grant that is configured to schedule transmission of a signal from the wireless node, wherein the grant indicates a reference modulation and coding scheme (MCS);
identifying a differential MCS based on the measurement and one of the multiple CSI-RS resources; and
outputting the signal for transmission, responsive to the grant, wherein the signal is output using the reference MCS and the differential MCS.
